(19) United States
(12) Patent Application Publication
(10) Pub. No.: US 2007/0183083 A1
(43) Pub. Date: Aug. 9, 2007

(54) Pivoting vertical mast of an accessor in an automated data storage library

(75) Inventors: Shawn M. Nave, Tucson, AZ (US); Stephen J. Roffinoli, Tucson, AZ (US); Raymond Yardy, Tucson, AZ (US)

Correspondence Address: Frank C. Nicholas;CARDINAL LAW GROUP, Suite 2000, 1603 Orrington Avenue, Evanston, IL, 60201, US

(73) Assignee: International Business Machines Corporation, Armonk, NY (US)

(21) Appl. No.: 11/350,431

(22) Filed: Feb. 9, 2006

(51) Int. Cl. G11B 15/68

(52) U.S. Cl. 360/92

(57) ABSTRACT

A cartridge accessor employs an accessor base, a vertical mast and a gripper mechanism. The accessor base is operable to translate the cartridge accessor in a horizontal direction within the automated data storage library. The vertical mast is pivotally coupled to the accessor base and the a gripper mechanism is translationally coupled to the vertical mast. The gripper mechanism is operable to translate relative to the vertical mast in a vertical direction within the automated data storage library, and the vertical mast is operable to pivot the vertical mast and the gripper mechanism relative to the accessor base.

### FIELD OF THE INVENTION

The present invention generally relates to the motion degrees of freedom of a robotic cartridge accessor in a linear or nonlinear automated data storage library. The present invention specifically relates to an accessor employing a vertical mast that is free to pivot 360 degrees relative to a horizontal moving accessor base.

### BACKGROUND OF THE INVENTION

FIG. 1 illustrates a cartridge accessor 10 employing a accessor base 11, a vertical mast 12 and a gripper mechanism 13. Cartridge accessor 10 has four motion degrees of freedom. The first motion degree of freedom is a horizontal translational motion of the entire accessor 10 along a horizontal ±X axis relative to a rail system (not shown) as shown in FIG. 1. The second motion degree of freedom is a vertical translational motion of the gripper mechanism 13 along a vertical ±Y axis relative to vertical mast 12 as shown in FIG. 1. The third motion degree of freedom is a 180 degree pivoting rotational motion of gripper mechanism 13 along a horizontal ±P semicircle relative to vertical mast 12 shown in FIG. 1. The fourth motion degree of freedom is a horizontal translational reach motion by a gripper 14 of gripper mechanism 13 relative to the horizontal ±P semicircle as shown in FIG. 1.

FIG. 2 illustrates one drawback associated with the design of cartridge accessor 10 as shown in FIG. 1. This drawback is an inability of gripper 14 to grab cartridges from any rotational orientation relative to vertical mast 12 due to a limited rotational access range of gripper 14. Specifically, as shown in FIG. 2, gripper 14 is capable of grabbing a cartridge located within an accessible zone AZ and is incapable of grabbing a cartridge located in an inaccessible zone IZ with both zones being defined by the limited 180 degree pivoting rotational motion of gripper mechanism 13 relative to vertical.

FIGS. 3A and 3B illustrate another drawback associated with the design of cartridge accessor 10 as shown in FIG. 1. This drawback is a creation of a dead zone within a storage area of an automated data storage library whereby it is of no use to place a cartridge holder (i.e., a storage slot or an input/output station) in that particular area due to the inability of gripper 14 to be rotated to an orientation relative to vertical mast 14 that provides access by gripper 14 to a cartridge supported by the cartridge holder. This is illustrated in FIG. 3A with a creation of dead zones DZ within a squared rectangular shaped storage area of an automated data storage library. Specifically, gripper mechanism 13 is capable of being rotated to an orientation relative to vertical mast 14 that provides access by gripper 14 (not shown) to a cartridge supported by a linear storage slot array 20 and a linear storage slot array 21. However, gripper mechanism 13 is incapable of being rotated to an orientation relative to vertical mast 14 that provides access by gripper 14 (not shown) to a cartridge supported by cartridge holder situated in the dead zone DZ.

This is illustrated in FIG. 3B with a creation of dead zones DZ within a rounded rectangular shaped storage area of an automated data storage library. Specifically, gripper mechanism 13 is capable of being rotated to an orientation relative to vertical mast 14 that provides access by gripper 14 (not shown) to a cartridge supported by a U-shaped storage slot array 22. However, gripper mechanism 13 is incapable of being rotated to an orientation relative to vertical mast 14 that provides access by gripper 14 (not shown) to a cartridge supported by cartridge holder situated in the dead zone DZ.

### SUMMARY OF THE INVENTION

The present invention provides a new and unique cartridge accessor employing a vertical mast that is free to pivot 360 degrees about a horizontal moving accessor base.

One form of the present invention is a cartridge accessor comprising an accessor base, a vertical mast and a gripper mechanism. The accessor base is operable to translate the cartridge accessor in a horizontal direction within the automated data storage library. The vertical mast is pivotally coupled to the accessor base and the gripper mechanism is translationally coupled to the vertical mast. The gripper mechanism is operable to translate relative to the vertical mast in a vertical direction within the automated data storage library, and the vertical mast is operable to pivot the vertical mast and the gripper mechanism relative to the accessor base.

A second form of the present invention is an automated data storage library comprising a cartridge holder and a cartridge accessor. The cartridge accessor includes an accessor base, a vertical mast and a gripper mechanism. The accessor base is operable to translate the cartridge accessor in a horizontal direction within the automated data storage library. The vertical mast is pivotally coupled to the accessor base and the gripper mechanism is translationally coupled to the vertical mast. The gripper mechanism is operable to translate relative to the vertical mast in a vertical direction within the automated data storage library, and the vertical mast is operable to pivot the vertical mast and the gripper mechanism relative to the accessor base to access at least one cartridge supported by the cartridge holder.

The aforementioned forms and additional forms as wells as objects and advantages of the present invention will become further apparent from the following detailed description of the various embodiments of the present invention read in conjunction with the accompanying drawings. The detailed description and drawings are merely illustrative of the present invention rather than limiting, the scope of the present invention being defined by the appended claims and equivalents thereof.

### BRIEF DESCRIPTION OF THE DRAWINGS

FIG. 1 illustrates a cartridge accessor as known in the art;

FIG. 2 illustrates a gripper mechanism illustrated in FIG. 1 as known in the art;

FIGS. 3A and 3B illustrate a block diagram of a top view of two versions of a linear automated data storage library as known in the art;

FIGS. 4 and 5 illustrate a block diagram of one embodiment of a cartridge accessor in accordance with the present invention;

FIG. 6 illustrates one embodiment of the cartridge accessor illustrated in FIGS. 4 and 5 in accordance with the present invention;

FIG. 7 illustrates a gripper mechanism illustrated in FIG. 6 in accordance with the present invention;

FIGS. 8A and 8B illustrate a block diagram of a top view of two embodiments of a linear automated data storage library in accordance with the present invention; and

FIG. 9 illustrates a second embodiment of a gripper mechanism in accordance with the present invention.

### DETAILED DESCRIPTION OF THE PRESENT INVENTION

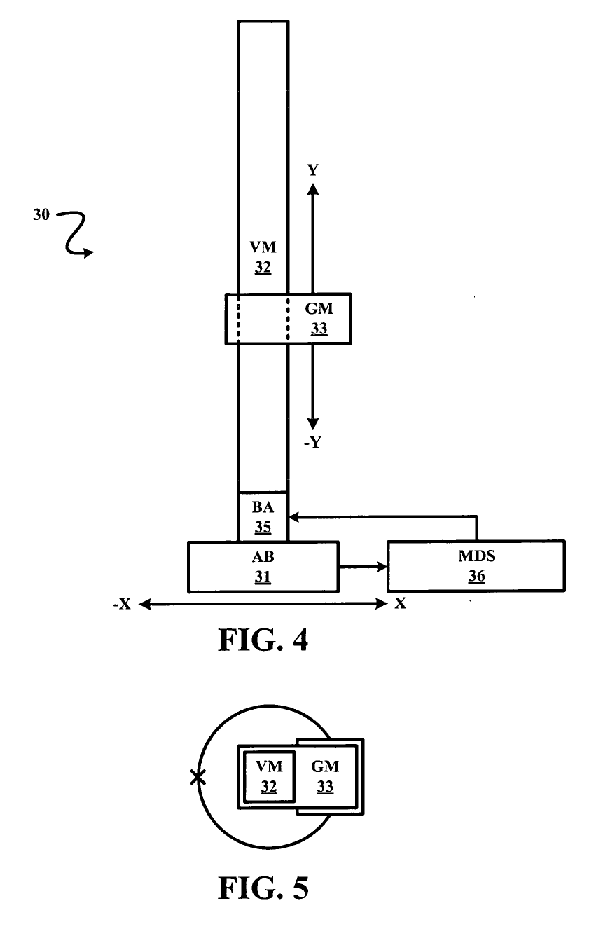

FIG. 4 illustrates a cartridge accessor 30 of the present invention employing an accessor base (“AB”) 31, a vertical mast (“VM”) 32 and a gripper mechanism (“GM”) 33. Accessor base 31 is transitionally coupled to a rail system (not shown) whereby accessor base 31 can be operated to translate cartridge accessor 30 in a horizontal direction as would be appreciated by those having ordinary skill in the art. A structural configuration of accessor base 31 can range from a simple mechanical platform for supporting vertical mast 32 and gripper mechanism 32 to a more elaborate design for additionally housing circuitry, sensors and/or other components for controlling one or more functions of cartridge accessor 30.

A bearing assembly (“BA”) pivotally couples vertical mast 32 to accessor base 31 whereby vertical mast 32 can be operated to pivot 360 degrees as shown in FIG. 5. Gripper mechanism 33 is translationally coupled to vertical mast 32 whereby gripper mechanism 33 can be translated in a vertical direction relative to vertical mast 32 as would be appreciated by those having ordinary skill in the art and can be pivoted with vertical mast 32 relative to accessor base 31.

A motor drive system (“MDS”) 36 is coupled to bearing assembly 35 and includes encoders (not shown) and a home position location sensor (not shown) to control a precise rotational orientation of vertical mast 32 and gripper mechanism 33 relative to accessor base 31. A transfer of power and a communication of a rotation command between a library (not shown) and cartridge accessor 30 can be accomplished in various ways as would be appreciated by those having ordinary skill in the art. The power is further transferred to motor drive system 36 as needed via in one of various ways, including, but not limited to, a slip ring/inductive coupling. The rotation command is further communicated to one or more control circuit cards (not shown) of motor drive system 36 as needed to direct bearing assembly 35 to execute a specific rotational movement of vertical mast 32 and gripper mechanism 33 relative to accessor base 31. The further communication of the rotation command can be accomplished in various ways, including, but not limited to a transfer over a slip ring, a modulation over an inductive coupling and a wireless transfer through radio frequency technology or infrared technology.

Cartridge accessor 30 has four motion degrees of freedom. The first motion degree of freedom is a horizontal translational motion of the entire cartridge accessor 30 along a horizontal axis ±X relative to a rail system (not shown) as shown in FIG. 4. The second motion degree of freedom is a vertical translational motion of the gripper mechanism 33 along a vertical ±Y axis relative to vertical mast 32 as shown in FIG. 4. The third motion degree of freedom is a 360 degree pivoting rotational motion of vertical mast 32 and gripper mechanism 33 along a horizontal circle in any direction relative to vertical mast 32 as shown in FIG. 5. The fourth motion degree of freedom is a horizontal translational reach motion by a gripper (not shown) of gripper mechanism 33 relative to the horizontal circle.

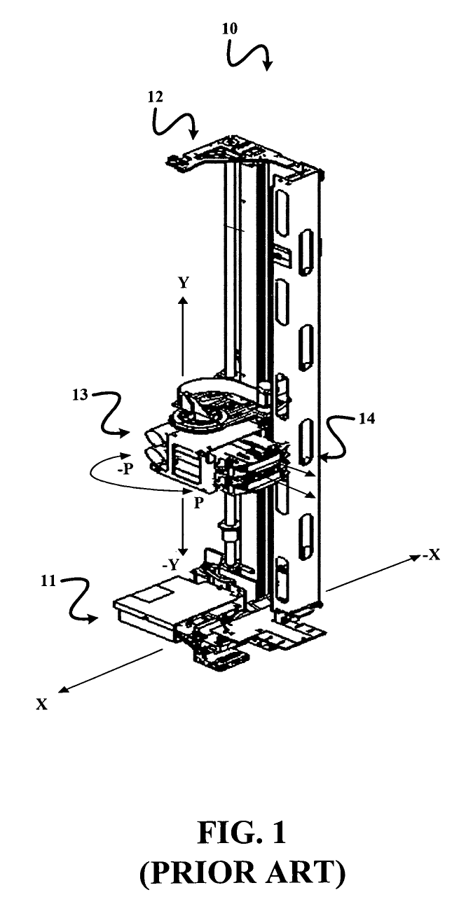

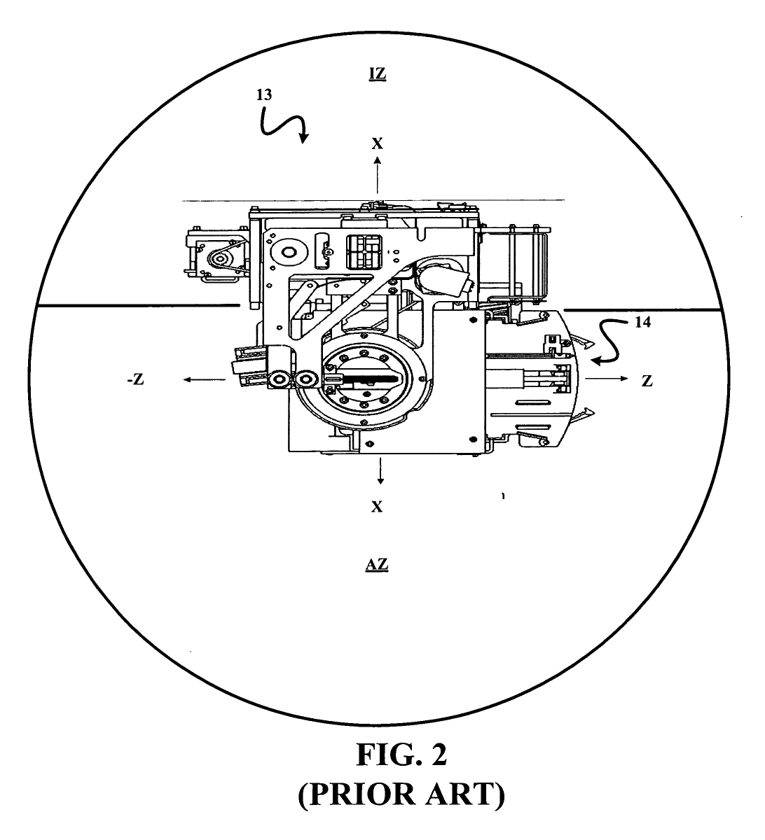

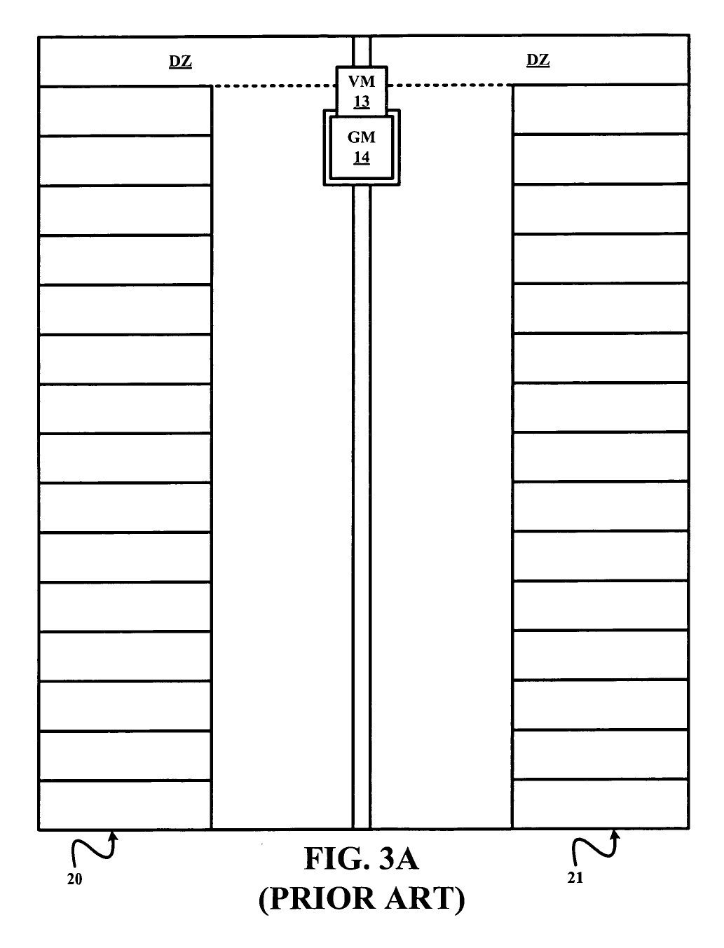

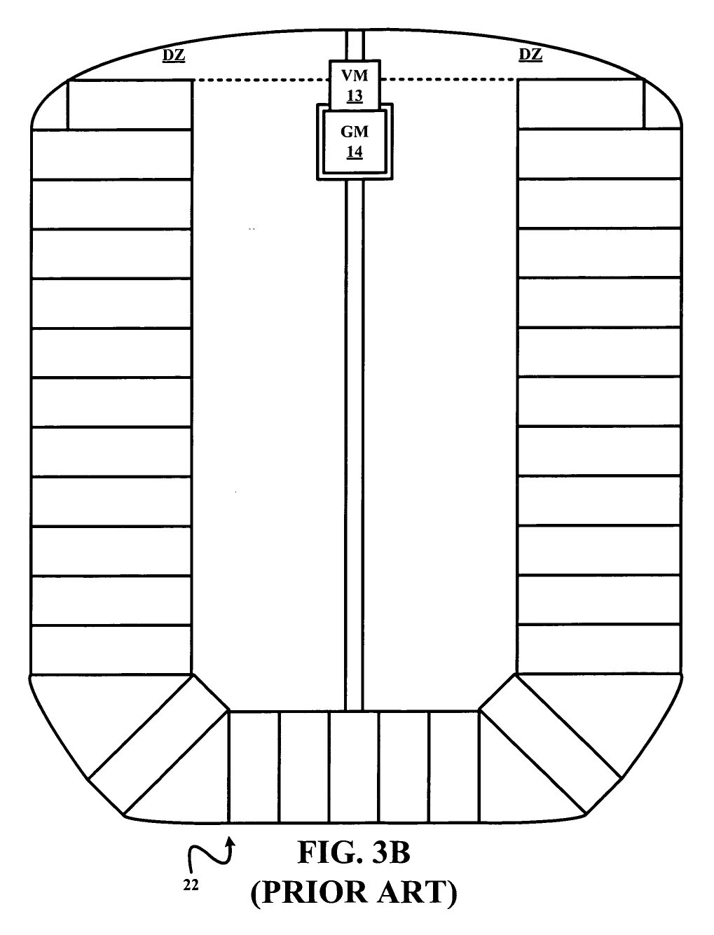

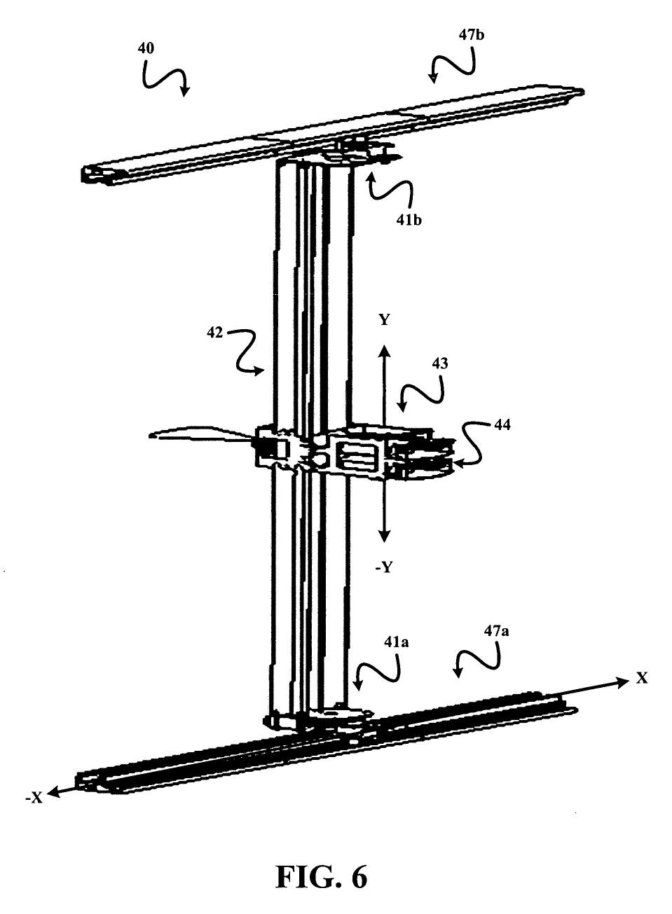

FIG. 6 illustrates a cartridge accessor 40 as one embodiment of cartridge accessor 30 (FIG. 1). Cartridge accessor 40 employs a lower accessor base 41a, an upper accessor base 41b, a vertical mast 42 and a gripper mechanism 44. Lower accessor base 41a is transitionally coupled to a lower rail system 47a and upper accessor base 41b is translationally coupled to an upper rail system 47b whereby accessor bases 41 can be operated to translate cartridge accessor 40 in a horizontal direction as would be appreciated by those having ordinary skill in the art. A lower bearing assembly (not shown) pivotally couples vertical mast 42 to lower accessor base 41a and an upper bearing assembly (not shown) pivotally couples vertical mast 42 to upper accessor base 41b whereby vertical mast 42 can be operated to pivot 360 degrees relative to accessor bases 41. Gripper mechanism 43 is translationally coupled to vertical mast 42 whereby gripper mechanism 43 can be translated in a vertical direction relative to vertical mast 42 as would be appreciated by those having ordinary skill in the art and can be pivoted with vertical mast 42 relative to accessor bases 41. A motor drive system (not shown) can be coupled to one or both bearing assemblies to control a precise rotational orientation of vertical mast 42 and gripper mechanism 43 relative to as accessor bases 41.

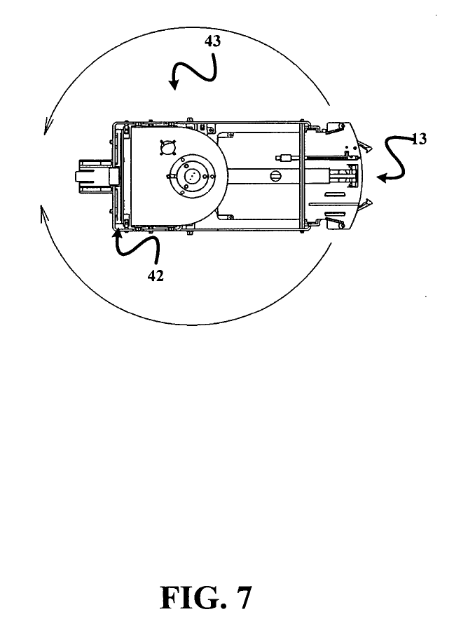

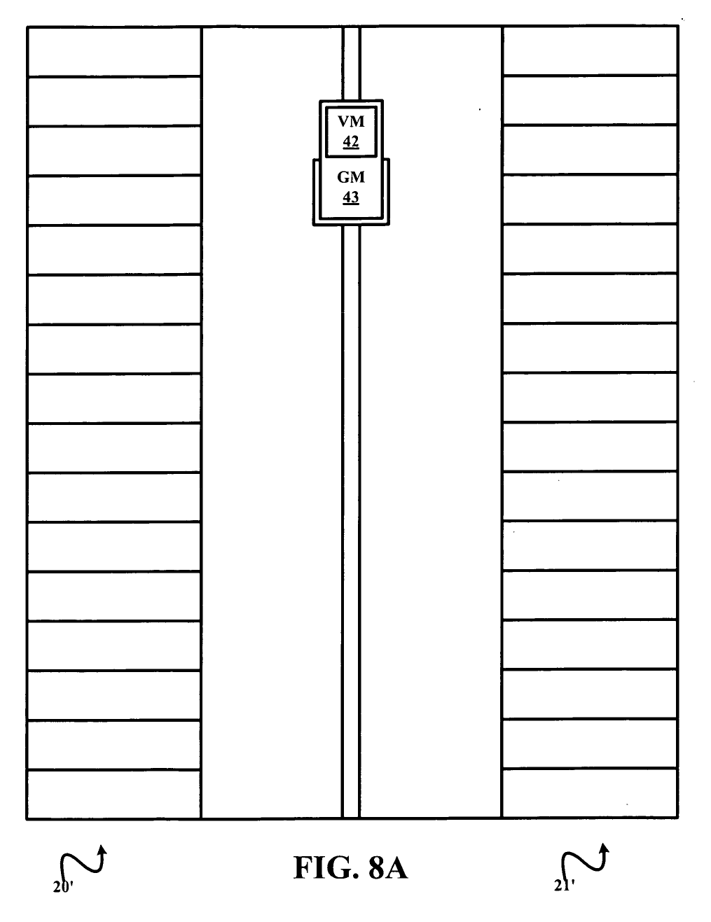

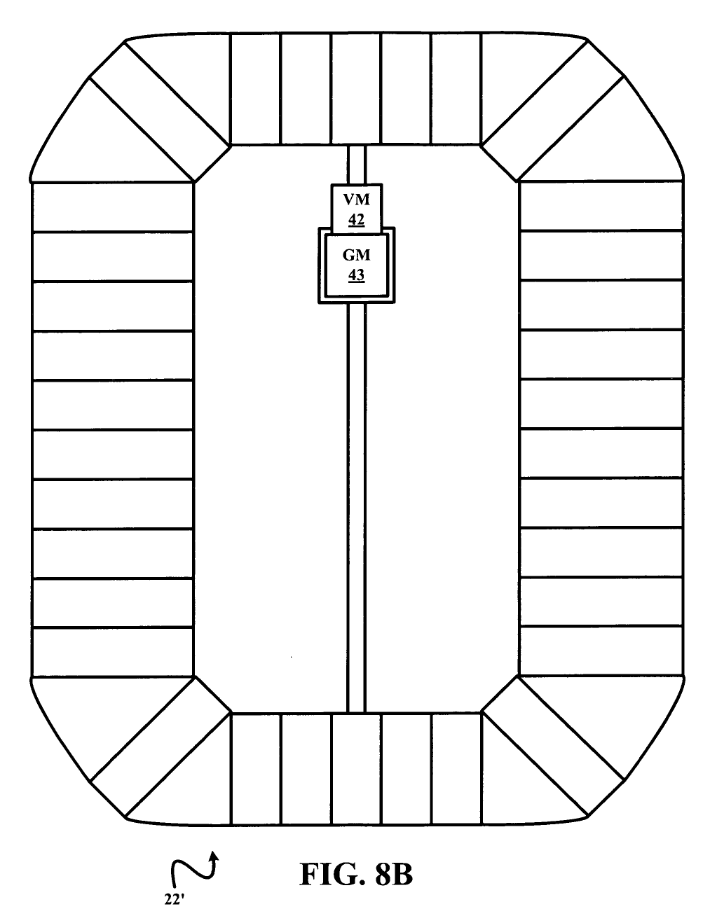

Cartridge accessor 40 has four motion degrees of freedom. The first motion degree of freedom is a horizontal translational motion of the entire cartridge accessor 40 along a horizontal axis ±X relative to a rail systems 47 as shown in FIG. 6. The second motion degree of freedom is a vertical translational motion of the gripper mechanism 43 along a vertical ±Y axis relative to vertical mast 42 as shown in FIG. 6. The third motion degree of freedom is a 360 degree pivoting rotational motion of vertical mast 42 and gripper mechanism 43 along a horizontal circle in any direction relative to accessor bases 41 as shown in FIG. 7. The fourth motion degree of freedom is a horizontal translational reach motion by a gripper 44 of gripper mechanism 43 relative to the horizontal circle as shown in FIG. 7. A result of the third motion degree of freedom and the fourth motion degree of freedom is vertical mast 42 and gripper mechanism 43 is capable of being rotated to an orientation relative to accessor bases 41 that provides access by a gripper 44 to a cartridge supported by a linear storage slot array 20′ and a linear storage slot array 21′ of a linear automated data storage library having a squared rectangular shaped storage area that is void of any cartridge supporting dead zones as shown in FIG. 8A, and that provides access by a gripper 44 to a cartridge supported by a rounded rectangular shaped storage slot array 22′ of a linear automated data storage library having a rounded rectangular shaped storage area that is void of any cartridge supporting dead zones as shown in FIG. 8B.

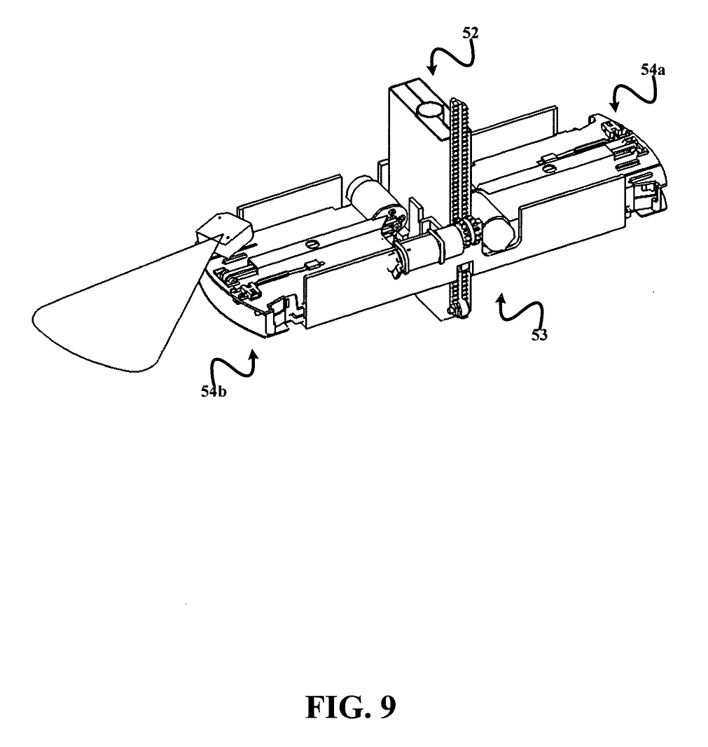

FIG. 9 illustrates a gripper mechanism 53 as an alternative to gripper mechanism 43 (FIG. 8). Specifically, each gripper 44 of gripper mechanism 43 can be operated to reach in the same horizontal direction as shown in FIG. 8 while a gripper 54a and a gripper 54b of gripper mechanism can be operated to reach in opposing horizontal directions as shown in FIG. 9 whereby gripper 54a is capable of reaching a cartridge within one hemisphere of the rotational circle and gripper 54b is capable of reaching a cartridge within the other hemisphere of the rotational circle. As such, while having the freedom to be rotated 360 degrees with a vertical mast 52 relative to an accessor base, vertical mast 52 and gripper mechanism 43 can be operated to rotate no more than approximately 180 degrees in order to access cartridges as needed.

Referring to FIGS. 4-9, those having ordinary skill in the art will appreciate the numerous advantages of the ability to rotate a gripper mechanism to any rotational orientation relative to the accessor base, including, but not limited to, the ability to place import/export stations and storage slot arrays at various angles in a storage area of an automated data storage library, particularly around corners in linear or non-linear data automated data storage libraries.

Those having ordinary skill in the art of cartridge accessors may develop other embodiments of the invention in view of the inventive principles of the present invention described herein. The terms and expression which have been employed in the foregoing specification are used herein as terms of description and not of limitations, and there is no intention in the use of such terms and expressions of excluding equivalents of the features shown and described or portions thereof, it being recognized that the scope of the invention is defined and limited only by the claims which follow.

We claim:

1. A cartridge accessor for an automated data storage library, the cartridge accessor comprising:
an accessor base operable to translate the cartridge accessor in a horizontal direction within the automated data storage library;
a vertical mast pivotally coupled to the accessor base; and
a gripper mechanism translationally coupled to the vertical mast,
wherein the gripper mechanism is operable to translate relative to the vertical mast in a vertical direction within the automated data storage library, and
wherein the vertical mast is operable to pivot the vertical mast and the gripper mechanism relative to the accessor base.

2. The cartridge accessor of claim 1, wherein the vertical mast is operable to pivot the vertical mast and the gripper mechanism 360 degrees relative to the accessor base.

3. The cartridge accessor of claim 1, wherein the gripper mechanism is operable to access a cartridge stored within the automated data storage library from any rotational orientation of the vertical mast and the gripper mechanism relative to the accessor base.

4. The cartridge accessor of claim 1, wherein the gripper mechanism is operable to access a cartridge stored at any location within a storage area of the vertical mast within the automated data storage library.

5. The cartridge accessor of claim 1, further comprising:
a bearing assembly pivotally coupling the vertical mast to the accessor base.

6. The cartridge accessor of claim 5, further comprising:
a motor drive system coupled to the bearing assembly, wherein the motor drive system is operable to control a precise rotational orientation of the vertical mast and the gripper mechanism relative to the accessor base.

7. The cartridge accessor of claim 6, wherein the accessor base is further operable to transfer power to the motor drive system.

8. The cartridge accessor of claim 1, wherein the gripper mechanism includes:
a first gripper operable to reach in a first direction; and
a second gripper operable to reach in the first direction.

9. The cartridge accessor of claim 8, wherein the gripper mechanism includes:
a first gripper operable to reach in a first direction; and
a second gripper operable to reach in a second direction.

10. The cartridge accessor of claim 9, wherein the first reach direction and the second reach direction are opposing directions.

11. An automated data storage library, comprising:
a cartridge holder; and
a cartridge accessor including:
an accessor base operable to translate the cartridge accessor in a horizontal direction within the automated data storage library;
a vertical mast pivotally coupled to the accessor base; and
a gripper mechanism translationally coupled to the vertical mast,
wherein the gripper mechanism is operable to translate relative to the vertical mast in a vertical direction within the automated data storage library, and
wherein the vertical mast is operable to pivot the vertical mast and the gripper mechanism relative to the accessor base to access at least one cartridge supported by the cartridge holder.

12. The automated data storage library of claim 11, wherein the vertical mast is operable to pivot the vertical mast and the gripper mechanism 360 degrees relative to the accessor base.

13. The automated data storage library of claim 11, wherein the gripper mechanism is operable to access a cartridge stored within the automated data storage library from any rotational orientation of the vertical mast and the gripper mechanism relative to the accessor base.

14. The automated data storage library of claim 11, wherein the gripper mechanism is operable to access a cartridge stored at any location within a storage area of the vertical mast within the automated data storage library.

15. The automated data storage library of claim 11, the cartridge accessor includes:
a bearing assembly pivotally coupling the vertical mast to the accessor base.

16. The automated data storage library of claim 15, the cartridge accessor further includes:
a motor drive system coupled to the bearing assembly, wherein the motor drive system is operable to control a precise rotational orientation of the vertical mast and the gripper mechanism relative to the accessor base.

17. The automated data storage library of claim 16, wherein the accessor base is further operable to transfer power to motor drive system.

18. The automated data storage library of claim 1, wherein the gripper mechanism includes:
a first gripper operable to reach in a first direction; and
a second gripper operable to reach in the first direction.

19. The automated data storage library of claim 18, wherein the gripper mechanism includes:
a first gripper operable to reach in a first direction; and
a second gripper operable to reach in a second direction.

20. The automated data storage library of claim 19, wherein the first reach direction and the second reach direction are opposing directions.
